(19) United States
(12) Patent Application Publication
(10) Pub. No.: US 2010/0078368 A1
(43) Pub. Date: Apr. 1, 2010

(54) DEVICE FOR TREATING BALLAST WATER WITH AQUEOUS ACROLEIN SOLUTION

(76) Inventor: Holger Blum, Teufen (CH)

Correspondence Address: NIXON PEABODY, LLP, 401 9TH STREET, NW, SUITE 900, WASHINGTON, DC, 20004-2128, US

(21) Appl. No.: 12/594,581

(22) PCT Filed: Nov. 28, 2007
(86) PCT No.: PCT/EP07/10334

§ 371 Date: Oct. 2, 2009

(30) Foreign Application Priority Data
Apr. 3, 2007 (DE) 20 2007 004 912.9

(51) Int. Cl. C02F 1/50; G05D 11/02

(52) U.S. Cl. 210/90; 210/101

(57) ABSTRACT

A device for treating of ballast water with aqueous acrolein solution is characterized in that the ballast water is pumped through a water jet pump (Z) by means of a pressure rising pump (VP), and that the negative pressure zone of the water jet pump is hydraulically connected with a non-circular, closed reaction container through a control valve (SV) which reaction container contains an eccentrically arranged intensive stirring unit (T) as well as separate supply ports for acrolein acetal (AC), acid (HX) and hydrolysis water (W) provided at the outside thereof.

It is already known, that ballast water on ships can be disinfected by using acrolein.

The document “Ballast Water Treatment R & D Directory”, 2^{nd} addition, November 2004, issued by the International Marine Organisation, London, describes on page 61 how the transfer of bacteria, algae, zebra-mussels and other organisms of the zooplankton from one marine port to another, can surely be suppressed by means of adding 1 to 15 ppm acrolein to the ballast water.

The advantage of adding acrolein is the sustained effect particularly against larvae of zebra-mussels and the fact that the acrolein disintegrates by themselves after some days which means that no new burdening of the marine port basin by this biocides is encountered upon discharging the ballast water in the port of destination.

On the one hand, the above advantages have been proven, but, on the other hand, there is the problem that handling, transportation and the storing of pure acrolein on ships can not be carried out because acrolein is a highly poisonous liquid with a tear gas effect, and the crew of the ship would be forced to carry out the handling of this biocide only after being protected completely by “NBC” (NBC=nuclear, biological and chemical) protective clothing and while using gas masks.

The aqueous solution of acrolein is not poisonous and can be safely handled. However, this solution is stable for only a few days so that the use of on ships is impossible because of logistic problems.

There have been many attempts to overcome the above mentioned difficulties thereby that a less dangerous derivative of acrolein is used in state of acrolein.

U.S. Pat. No. 5,183,944 proposes to decompose, instead of acrolein, a non poisonous aqueous acrolein acetal at the location of usage with an aqueous acid solution, and, thereafter, to remove the acrolein formed from the acetal, from the reaction mixture by means of an inert gas stream. The acrolein containing inert gas flow then serves for the treatment of the water. In order to use this method on board of a ship, absolutely reliable, double walled conduits have to be installed for the highly poisonous acrolein-gas-mixture.

Upon introducing the acrolein containing gases into the ballast water tanks, the inert gas is discharged from the ventilation conduits of the ballast water tank, and it still contains such an amount of residual acrolein that working on deck is impossible because of the tear gas effect and that a dangerous operation condition is encountered. Furthermore, a water containing residual product is generated in the method according to U.S. Pat. No. 5,183,944 which product can be disposed of an board of a ship only with difficulties.

U.S. Pat. No. 5,560,833 proposes the use of an alcoholic solution of acrolein acetal and acid cleavage for forming an acrolein solution at the location of usage. Acrolein acetal dissolved in isopropyl alcohol and a diluted 10%-mineral acid are mixed under pressure in a pipe coil to form a homogenous reaction solution. Thereafter, the mixture is passed slowly through a storage tank in a laminar flow until the deacetalation of the acrolein acetal is completely finished.

In another embodiment of the U.S. Pat. No. 5,560,833 a circulation mixer in form of a pipe without high interior turbulence and with a slowly moving multiple stirring unit is used as a storage tank instead of the storage tank itself. The pipe coil for mixing the alcoholic acetal solution and the diluted mineral acid is arranged, in this example, as an interior installation coaxially with respect to the tube shaped stirring mixer.

It is a precondition for carrying out this method for producing acrolein on board of a ship that a pre-mixture of isopropyl alcohol and acetal as well as a pre-mixture out of concentrated mineral acid and water have to be produced on site. According to the patent teaching of the U.S. Pat. No. 5,560,833, these two pre-mixtures have to be transferred each to a pressure container in order to be ready for use.

For both operations, there is no trained personal on board of a sea ship. Additionally, there is a fire hazard in handling easily volatile, inflammable C1 to C3-alcohols without protective gas. It has been found by working the method of U.S. Pat. No. 5,560,833, that the proposed devices had only a short life time and became unusable thereafter when they did not consist out of glass but out of acid resistant high-grade steel as is usual.

After a short operation time period of the device according to U.S. Pat. No. 5,560,833 resin like coating out of bisacrolein and other condensation products of the acrolein on the walls of the storage tanks out of high-grade steel and on the tube shaped stirring mixers which came into contact with the liquid. This disadvantageous effect occurred in particular at locations with laminar flow and only low turbulence.

Because of the above mentioned deficiencies, the above proposed devices according to U.S. Pat. No. 5,183,944 and U.S. Pat. No. 5,560,833 can not be used for treating of ballast water with acrolein on board of ships.

It is the object of the invention to provide a device easily to be installed, with which ballast water can be treated with acrolein on board of ships and the operation of which device is ensured also after long operational time periods without dangerous operation states being encountered and/or pre-mixtures having to be produced.

For achieving this object, the device of the invention is characterized in that the ballast water is pumped through a water jet pump by means of a pressure rising pump, and in that the negative pressure zone of the water jet pump is connected hydraulically through a control valve to a non-circular reaction container which does not contain any stationary interior installations but contains only an eccentrically arranged intensive stirring unit as well as separate supply ports for supplying acrolein acetal, acid and hydrolysis water from outsides. In spite of this simple construction, an extremely reliable and trouble-free treatment of ballast water with a diluted aqueous solution of acrolein is achieved in an advantageous way.

A further advantage resides in that pure acrolein is not present at any location within the device which means additional security against occurrence of dangerous operation states. A safe operation of the devices is also ensured upon varying or interrupted supply of ballast water. Since the non-circular reaction container in which the deacetalation takes place, is always completely filled, the trouble-free function of the device is also not adversely affected also in the case of heavy see condition.

The eccentric arrangement of the intensive stirring unit has the result that no thrombus shaped stirring forms are formed in the non-circular reaction container also in the case of high input of stirring energy, and that, thereby, one of the main reasons for the occurrence of resin like coatings of the metallic walls of the device is removed.

The above described, compact device for treating ballast water with acrolein provides a surprising number of important technical advantageous. Acrolein acetal can be directly used with the device of the invention without a pre-mixture with a solvent being necessary. The same is true for the acid which is used as a catalyst which acid can be dosed into the device as supplied and without prior dilution with water. It is particularly advantageous with the arrangement of the device according to the invention that the already available on-board water supply system can be used for supplying the water for the hydrolysis whereby additional dosage pumps and control devices become unnecessary. In particular, the supply of water with a fixed supply rate into the device irrespective of the operational state thereof is an additional security measure against un-thoughtful operation or in case of break down of the current supply.

In the device of the invention for treating ballast water with acrolein, a single control valve in the connecting conduit between the non-circular reaction container and the negative pressure zone of the water jet pump controls the supply of aqueous acrolein solution. According to an advantageous embodiment of the invention, the control valve is a security valve with adjustable opening pressure whereby it is ensured that the acrolein solution flows to the negative pressure zone only in case the pressure rising pump is working.

According to an advantageous embodiment of the invention, the non-circular reaction container comprises the shape of a closed box. The height of the box corresponds approximately to its breadth and the ratio of the length of the box to its height amounts to 1.2.

According to an advantageous embodiment of the invention, the intensive stirrer has the shape of a turbine stirrer wherein the stirring energy input per cubic meter volume of the box amounts to more than 500 Watt. The diameter of the turbine stirrer amounts approximately to 0.3 times the breadth of the box.

According to an advantageous embodiment of the invention, the intensive stirrer is arranged eccentrically in relation to the length of the box in the interior space of the box. The relation of the eccentricity to the length of the box amounts to approximately 0.1 to 0.2. The distance of the intensive stirrer from the bottom of the box is approximately equal to the diameter of the turbine stirrer.

The box of the invention for preparing the aqueous acrolein solution is, furthermore, characterized by three supply ports for acrolein acetal, catalyst acid and for hydrolysis water.

According to an advantageous embodiment of the invention, the supply ports for acrolein acetal and catalyst acid are pipe portions which are welded to the cover of the box. On the two pipe portions, check valves are mounted which prevent aqueous acrolein solution from passing out of the box into the supply lines for acrolein acetal and for catalyst acid.

According to an advantageous embodiment of the invention, the supply port for supplying the hydrolysis water into the box is a circular gap between the stirrer shaft and the opening for the stirrer shaft in the cover of the box. The hydrolysis water gets to the ring gap through a tube portion at the sealing hub of the stirrer shaft and forms, thereby, an inhibiting water flow against discharge of aqueous acrolein solution out of the box.

According to an advantageous embodiment of the invention, the box comprises an outer cooling jacket having supply and discharge ports for cooling water such that the reaction solution within the box may be maintained at a temperature of below 35° Celsius.

According to an advantageous embodiment of the invention, the intensive stirrer is driven by an electric motor the rotational speed of which is adapted to be adjusted by means of a frequency converter.

According to an advantageous embodiment of the invention, the device comprises an electric or pneumatic control unit which interrupts the supply of acrolein acetal and catalyst acid to the box in case the pressure in the negative pressure zone of the water jet pump exceeds a predetermined value.

According to an advantageous embodiment of the invention, the device comprises an electric or pneumatic control unit which interrupts the supply of acrolein acetal and catalyst acid to the box in case the supply of hydrolysis water is interrupted.

According to an advantageous embodiment of the invention, the device comprises an electric or pneumatic control unit which interrupts the supply of acrolein acetal and catalyst acid to the box in case the drive motor of the stirrer shaft is at rest.

According to an advantageous embodiment of the invention, an electric motor controlled by a frequency converter serves as a driving means for the pressure rising pump whereby an effective control of the input pressure in the water jet pump is achieved and the control of the device of the invention can be carried out by analog or digital computer systems in a simple way.

According to an advantageous embodiment of the invention, a control unit is provided which is configured to control the rotational speed of the pressure rising pump depending on the process parameters of the device for treating of ballast water with acrolein.

According to an advantageous embodiment of the invention, the process parameter is the pressure difference between the supply to and the discharge from the water jet pump.

According to an advantageous embodiment of the invention, the control unit on the basis of the pressure difference comprises at least two pressure sensors and a measurement converter which is configured to determine the pressure difference from the measurement values from the pressure sensors, to conduct a comparison between nominal value and actual value and to output a resulting control signal to the rotational speed control of the motor.

Embodiments of the invention are now described with reference to the attached drawings in which:

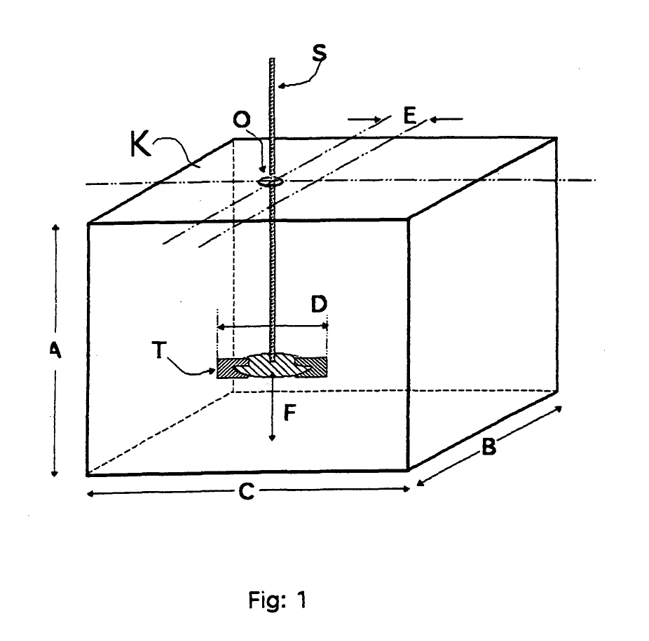

FIG. 1 schematically shows the non-circular reaction container in the shape of a closed box which the intensive stirrer eccentrically arranged therein;

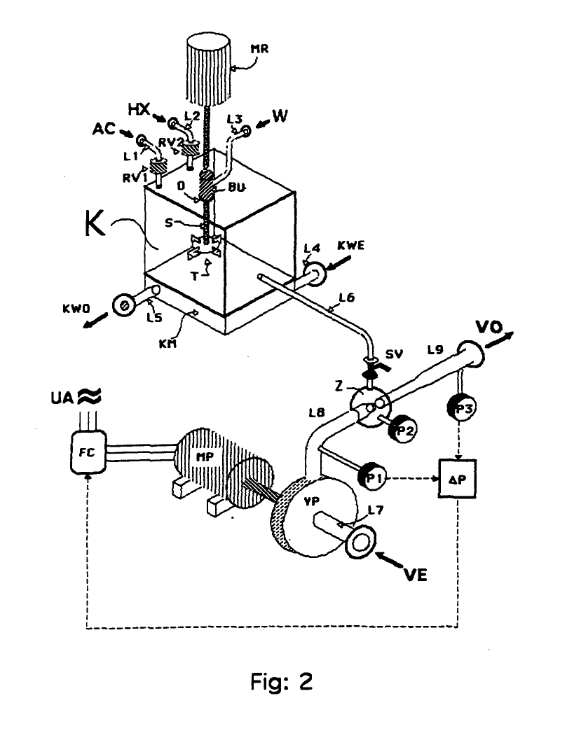

FIG. 2 schematically shows the respective flow scheme of the device of the invention for treating of ballast water with acrolein; and

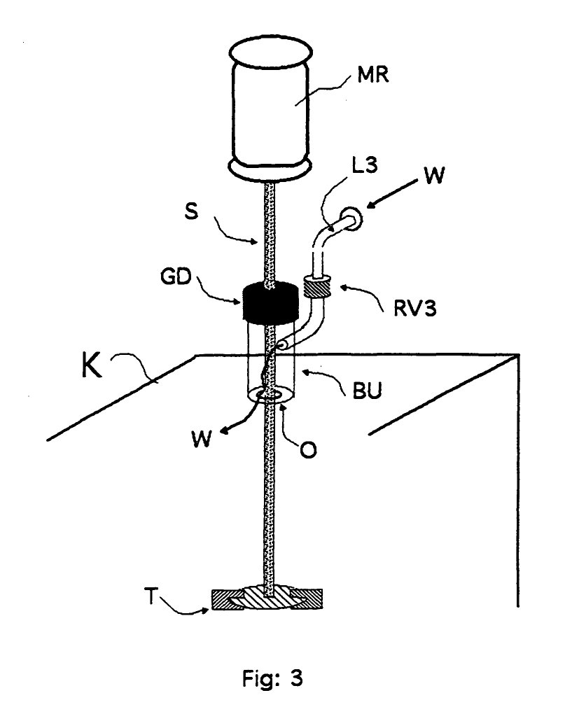

FIG. 3 schematically shows the supply of hydrolysis water into the box.

1. As can be seen from FIG. 1, the non-circular reaction container has the shape of a closed box K. The box K has a height A, a breadth B and a length C and includes no stationary interior installations. The intensive stirring element T is fixedly connected to the stirrer shaft S. The stirrer shaft S extends through the opening O in the cover of the box. The stirrer shaft S and, thereby, the stirring element T is arranged eccentrically by a distance E from half of the box length C. The stirring element has the diameter D and is positioned at a distance F from the bottom of the box. As an alternative, not shown, several intensive stirring elements may be arranged in the interior of the box (K).

The rotating speed of the stirring element T is variable such that a mechanical stirring power of at least 500 Watt per cubic meter of the volume of the box can be generated. The box K is filled completely with reaction liquid, it does not contain any thrombus shaped form of liquid because of the high turbulence, and no resin formation occurs from the aqueous acrolein produced because there are no stationary interior installations.

Details of the device of the invention can be taken from FIG. 2. As can be seen from FIG. 2, the flow VE (volume/unit time) of the ballast water to be treated with acrolein, flows through the conduit L7 into the intake pipe of the pressure rising pump VP. The ballast water flows through the pressure conduit L8 into the water jet pump Z and is mixed with the aqueous acrolein solution being sucked into the negative pressure zone through the control valve SV. The ballast water treated with the acrolein is discharged from the device of the invention through the conduit L9 as a stream VO (volume/unit time).

The rotational speed of the pressure rising pump VP is variable. For example, the drive motor MP may be a three-phase motor the rotational speed of which is controlled by a frequency converter FC. This frequency converter is connected to the mains cable AC and obtains its control signal as a signal current, for example 4-20 mA (or as a signal voltage 0 to 5 Volt from the controller designated by ΔP in FIG. 2, and from a measurement converter.

The control unit ΔP is connected with two pressure sensors P1 and P3. The measurement converter of the control unit ΔP calculates the differential pressure from the input signals of the pressure sensors P1 and P3 and compares this differential pressure with an predetermined nominal value. The deviation between nominal value and actual value is fed to the frequency converter FC as a control signal. By means of this control circuit, it is ensured that the pressure P2 in the negative pressure zone of the water jet pump Z does not exceed a minimal value also in the case of a varying supply of ballast water, and that the supply of aqueous acrolein solution to the ballast water is affected continuously and without disturbance.

As can be seen from FIG. 2, the negative pressure zone of the water jet pump Z is hydraulically connected to the drainage conduit L6 welded to the box K, by means of the control valve SV. The reaction liquid from the box K flows to the conduit L6 into the water jet pump because of the pressure difference between the low over pressure in the interior of the box K and the negative pressure P2 in the negative pressure zone of the water jet pump Z.

Because of this advantageous arrangement of the device of the invention, a separate feeder pump for the diluted aqueous acrolein solution is not necessary whereby the operational security of the device is significantly enhanced.

The box K comprises an outer cooling jacket KM having a supply pipe portion L4 for coolant stream KWE and a coolant discharge pipe portion L5 for the discharged coolant stream KWO. Water or another usual coolant can serve as a coolant means.

As can be seen, the box K does not comprise any stationary interior installations but only the stirring unit eccentrically arranged with respect to the longitudinal axis of the box, the stirring unit consisting out of the stirring element T which is shown as stirring turbine, and the stirrer shaft S which is connected to the drive motor MR.

The opening for the stirrer shaft S in the upper cover of the box is designated by O and has a somewhat larger opening diameter than the stirrer shaft itself. The stirrer shaft is axially centrally adjusted with respect to the opening of O. The hydrolysis water W, which is necessary for the hydrolysis of the acrolein acetat, flows through the ring gap between the opening O and the shaft S. The sealing hub BU which is internally hollow, is screwed onto the cover of the box in liquid-tight relationship. At its upper end, the hub BU is sealed with respect to the stirrer shaft S by means of a packing case or a phase seal to avoid leakage of water or reaction liquid out of the box K.

The supply conduit L3 for the continuously supplied hydrolysis water W is screwed to the sealing hub BU.

By means of this advantageous embodiment of the invention, the hydrolysis water W simultaneously also serves as a blocking water for mechanical sealing of the stirrer shaft S with respect to the box K.

As can be seen, the cover of the box comprises two further supply ports which are arranged as far as possible away from the discharge conduit 6. The supply conduit L2 supplies continuously the acid HS which is necessary for cleaving the acrolein acetal to the box K. The supply conduit L1 supplies continuously acrolein acetal to the box K. In order to prohibit liquid to get from the box K into the supply conduits L1 and L2, those conduits are provided with check valves RV1 and RV2.

In practise, the pressure in the supply line L3 for hydrolysis water W will amount to some bars, and, therefore, hat a check valve is not necessary in this supply line.

When starting the device of the invention and during the treatment of the ballast water with aqueous acrolein solution, the supply amount per unit time of the hydrolysis water is fixedly adjusted. Thereby, it is assured that the box K and the conduit L6 are completely filled with water at the beginning. Thereafter, the stirring unit MR is started. As soon as the pressure rising pump VP is controlled to its nominal operation and the negative pressure P2 has reached the prescribed value, the continuous supply of acid HX to the supply line L2 to the box K is started. An acid as stated in U.S. Pat. No. 5,183,944 may be used as an acid for the deacetalation. Several minutes after the beginning of the acid supply, the supply pump for the acrolein acetal AC is started, and the acrolein acetal is pumped through supply line L1 into the box K.

After the treatment of the ballast water has been finished, the supply streams for acrolein acetal AC acid hydrolysis water HX and W are switched off in the opposite sequence whereby it is insured that the device is again filled only with water at the end.

In case a disturbance should occur during the treatment of the ballast water, for example by breakdown of the pump VP and in case, as a result thereof, the negative pressure P2 exceeds the prescribed value, the supply streams of acrolein acetal AC and acid HX to the box K are switched off by means of a security circuit (not shown).

Details of the shut-off water circuit and of the supply of the hydrolysis water W into the box K of the device of the invention can be taken from FIG. 3.

As can be seen from this drawing, the hub BU which is sealungly to the box K, is formed as a hollow cylinder. A mechanical seal GD to the stirrer shaft S is arranged at the upper end of the hub BU. The seal GD may be a packing case having packing rings or, advantageously, a phase seal.

The hub BU comprises a screw threaded opening or a flange socket to which the supply line L3 for the hydrolysis water W is fluid-tightly attached.

The hydrolysis water W is introduced under pressure through the pipe line L3 and through the check vale RW3 into the hub BU from the side, flows around the stirrer shaft in the direction of the ring gap which is formed by the opening O in the cover of the box and the stirrer shaft axially centrally arranged in O, downwards and which is the interior of the box K.

By means of the forced flow conditions in the ring gap, reaction solution can not get from the interior of the box K into the interior of the hub BU.

In case the sealing GD should fail, water W will exit the device of the invention but no reaction solution.

1. Device for treating of ballast water with aqueous acrolein solution characterized in that the ballast water is pumped through a water jet pump (Z) by means of a pressure rising pump (VP), and that the negative pressure zone of the water jet pump is hydraulically connected with a non-circular, closed reaction container through a control valve (SV) which reaction container contains an eccentrically arranged intensive stirring unit (T) as well as separate supply ports for acrolein acetal (AC), acid (HX) and hydrolysis water (W) provided at the outside thereof.

2. Device according to claim 1, characterized in that the intensive stirring element (T) is a turbine stirrer.

3. Device according to claim 1, characterized in that the non-circular reaction container has the form of a closed box (K).

4. Device according to claim 1, characterized in that the stirring power mechanically input into the box is larger than 0.5 k Watt per cubic meter box volume.

5. Device according to claim 1, characterized in that the dimensional relationship between height (A) to length (C) to breadth (B) of the box (K) is approximately 1 to 1.2 to 1.

6. Device according to one of the claims 1 to 3, characterized in that the relationship of the breadth of the box (B) to the diameter (D) of the stirring turbine is approximately 3, and that the relationship of the diameter of the stirring turbine (D) to the distance to the bottom (F) is approximately 1.

7. Device according to one of the claims 1 to 5, characterized in that the eccentricity (E) of the stirrer shaft is approximately 0.1 to 0.2 times the length (C) of the box.

8. Device according to claim 1, characterized in that the supply opening for the hydrolysis water is the ring gap between the stirrer shaft (S) and the opening (O) for the stirrer shaft in the cover of the box.

9. Device according to claim 1, characterized in that the box (K) is completely filled with liquid.

10. Device according to claim 1, characterized in that the box (K) comprise an outer cooling jacket (KM).

11. Device according to claim 1, characterized in that several intensive stirring elements are arranged in the interior of the box (K).

12. Device according to claim 1, characterized in that an electric motor (MP) controlled by means of a frequency converter (FC), serves as a drive for the pressure rising pump (VP).

13. Device according to claims 1 and 11, characterized by a control unit (ΔP) carrying out a comparison of the nominal value to the actual value by measuring the pressure difference of the ballast water upon discharge from the pressure rising pump (P1) and upon discharge from the device (P3), and which outputs a resulting control signal to the frequency converter (FC) of the pressure rising pump (VP).
